(19) United States
(12) Patent Application Publication
(10) Pub. No.: US 2008/0284494 A1
(43) Pub. Date: Nov. 20, 2008

(54) FUSE DEVICE, METHOD FOR WRITING DATA, METHOD FOR READING DATA, AND METHOD FOR WRITING AND READING DATA

(75) Inventors: Hideaki Yamauchi, Tokyo (JP); Akikuni Sato, Kanagawa-ken (JP); Takehiko Hojo, Kanagawa-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/118,033

(22) Filed: May 9, 2008

(30) Foreign Application Priority Data
May 10, 2007 (JP) 2007-125875

(51) Int. Cl. H01H 37/76

(52) U.S. Cl. 327/525

(57) ABSTRACT

A fuse device includes a plurality of serially connected fuse elements whose number is n (n is an integer of two or more), a power source connected to one end of a first fuse element that is a top of the n serially connected fuse elements, and a plurality of program control transistors. Each of the program control transistors is connected to each of nodes between the fuse elements, and to an end of the n-th fuse element, respectively.

### CROSS-REFERENCE TO RELATED APPLICATIONS

This application is based upon and claims the benefit of priority from the prior Japanese Patent Application No. 2007-125875, filed on May 10, 2007; the entire contents of which are incorporated herein by reference.

### BACKGROUND OF THE INVENTION

1. Field of the Invention

This invention relates to a fuse device, a method for writing data to the fuse device, and a method for reading data from the fuse device.

2. Background Art

Conventionally, an element-melt-cutting type e-Fuse is composed of one fuse element and a program control transistor. The program control transistor is set to be ON and a program voltage is applied to pass a high current through the fuse element, and thereby, the fuse element is broken and resistance of the fuse element is increased, and thereby, data is written. The fuse element is composed of a polysilicon film and a silicide layer formed on the surface thereof. The resistance is raised by melt-cutting the suicide layer.

In order to more enhance a shift of the resistance of the fuse element, another conventional technique includes a fuse device in which two fuse elements (first and second fuse elements) are disposed side by side and breaking of the fuse elements is controlled by two control transistors connected to the respective fuse elements. The fuse device has a structure in which these program control transistors are switched ON or OFF to break the two respective fuse elements in the sequence of breaking of the first fuse element (breaking 1) and breaking of the second fuse element (breaking 2), and last, data is read. Moreover, for enhancing shift of the resistance of the fuse element(s), the number of the same fuse element can be increased and disposed side by side.

In the above-described conventional techniques, a high current Is passed through the fuse element(s) to break the fuse element(s). However, the current has to be in an extent of not breaking the peripheral circuits. As a result, there is a possibility that the change of the resistance after breaking is small depending on the degree of breaking of the fuse element(s), and there is a problem that it becomes difficult to determine [0, 1] readout of data. Moreover, in the device in which the fuse elements are disposed side by side, the change of the resistance value becomes large because the number of times of breaking increases by the number of the fuse elements disposed side by side, but there is a problem that the program control transistor is wasted to enlarge the circuits.

In JP-A 2004-214580 (Kokai), there has been disclosed a fuse layout and a trimming method by which the cutting fault of the fuse remaining is reduced to improve yield and reliability and thereby the operation time of the trimming step can be shortened. In a fuse layout formed on a wire electrode having a barrier metal layer composed of high-melting point metal and a main wire metal layer, the layout having a plurality of serially connected melt-cutting-type fuse parts 11, 12 and a plurality of fuse pads 13, 14, 15 for carrying currents through the respective melt-cutting-type fuse parts are used, and when at least one of the plurality of fuse parts is cut, the layout comes to be cut as a whole, and thereby, the cutting fault rate of remaining can be drastically reduced. Moreover, even if a barrier metal layer remains with no cut, because of the high resistance, the fuse resistance value becomes very high as a whole of the layout, this state can be considered to be equal to a cut state.

### SUMMARY OF THE INVENTION

According to an aspect of the invention, there is provided a fuse device including: a plurality of serially connected fuse elements whose number is n (n is an integer of two or more); a power source connected to one end of a first fuse element that Is a top of the n serially connected fuse elements; and a plurality of program control transistors, each of the program control transistors being connected to each of nodes between the fuse elements, and to an end of the n-th fuse element, respectively.

According to another aspect of the invention, there is provided a method for writing data to a fuse device having a plurality of serially connected fuse elements whose number is n (n is an integer of two or more); a power source connected to one end of a first fuse element that is a top of the n serially connected fuse elements; and a plurality of program control transistors, each of the program control transistors being connected to each of nodes between the fuse elements, and to an end of the n-th fuse element, respectively, the method including: setting the program control transistor connected to the n-th fuse element out of the n serially connected fuse elements, to be in a state of ON; setting the program control transistor connected to each of other fuse elements, to be in a state of OFF; applying a program voltage from the power source to break the n-th fuse element; setting the program control transistor connected to the (n−1)-th fuse element, to be in a state of ON; setting the program control transistor connected to each of the first through (n−2)-th fuse elements and the n-th fuse element, to be in a state of OFF; applying a program voltage from the power source to break the (n−1)-th fuse element; sequentially breaking the (n−2)-th fuse element, . . . , second fuse element, and the first fuse element, in a same manner; and thereby breaking all of the n fuse elements.

According to another aspect of the invention, there is provided a method for reading data from a fuse device having a plurality of serially connected fuse elements whose number is n (n is an integer of two or more); a power source connected to one end of a first fuse element that is a top of the n serially connected fuse elements; and a plurality of program control transistors, each of the program control transistors being connected to each of nodes between the fuse elements, and to an end of the n-th fuse element, respectively, the method Including: setting the program control transistor connected to the n-th fuse element at a last stage of the n serially connected fuse elements, to be in a state of ON; setting the other program control transistors to be in a state of OFF; and applying a program voltage from the power source to perform readout.

### BRIEF DESCRIPTION OF THE DRAWINGS

FIGS. 1A to 1D are cross-sectional views of a fuse device for explaining an initial state of the fuse device, a breaking method, and a reading method according to an example 1 of the invention;

FIGS. 2A to 2E are cross-sectional views of a fuse device for explaining an initial state of the fuse device, a breaking method, and a reading method according to an example 2 of the invention;

FIGS. 3A to 3E are cross-sectional views of a fuse device for explaining an initial state of the fuse device, a breaking method, and a reading method according to an example 3 of the invention; and

FIGS. 4A to 4D are cross-sectional views of a fuse device for explaining an initial state of the fuse device, a breaking method, and a reading method according to an example 4 of the invention.

### DETAILED DESCRIPTION OF THE INVENTION

Hereinafter, embodiments of this invention will be described with reference to examples.

### Example 1

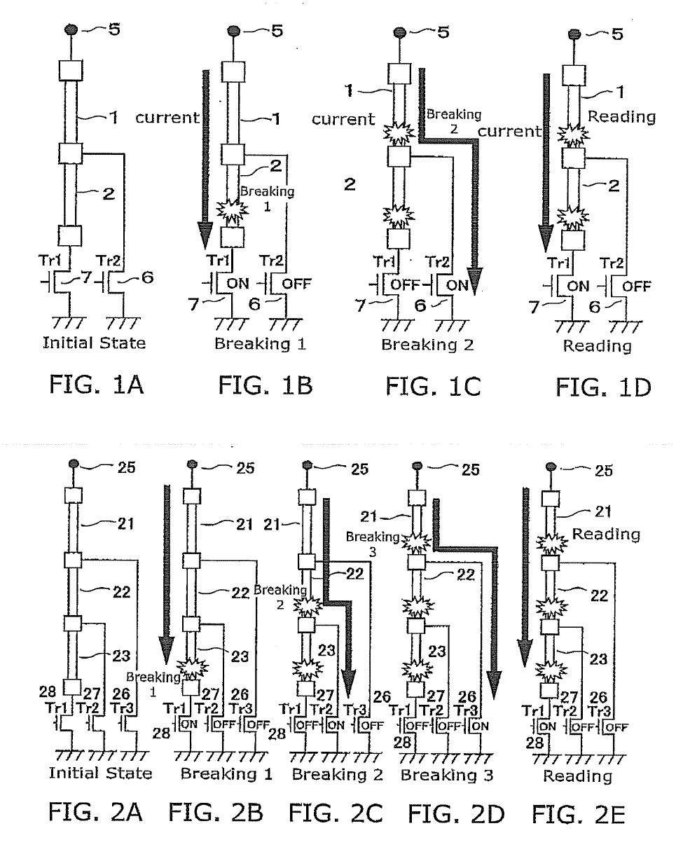

First, Example 1 will be described with reference to FIG. 1.

FIGS. 1A to 1D are schematic views of a fuse device for explaining an initial state of the fuse device, a breaking method, and a reading method. The fuse device includes, a head fuse element 1 and a back-stage fuse element 2 which are serially connected, a program control transistor (MOS transistor Tr2) 6 connected to the head fuse element 1, a program control transistor (MOS transistor Tr1) 7 connected to the back-stage fuse element 2, a power source 5 connected to an end of the head fuse element 1. A source region or a drain region of the program control transistor 6 is connected to one end of the fuse element 1, and the drain region or the source region is earthed. A source region or a drain region of the program control transistor 7 is connected to one end of the fuse element 2, and the drain region or the source region is earthed.

In this Example, as the fuse elements, polysilicon wires are used. The polysilicon wire is composed of a polysilicon film and a silicide layer formed on the surface of the polysilicon film. The fuse device is subjected to the writing treatment by breaking the fuse element(s). Breaking of the fuse element(s) is performed by applying program voltage to the fuse element to melt and cut the silicide layer on the polysilicon film.

FIG. 1A shows the initial state of the fuse device.

Next, the writing method of the fuse device will be described. Writing is performed by breaking the two fuse elements. First, as shown in FIG. 1B, the program control transistor 7 is set to be in a state of ON, and the program control transistor 6 is set to be in a state of OFF, and program voltage is applied from the power source 5 to pass a current as shown by the arrow to break the fuse element 2 (breaking 1). It is preferable that the fuse element 2 is more easily broken than fuse element 1. One of the methods is that the fuse element 2 is broken at a current which is lower than a current at which the fuse element 1 is broken. For example, by making the width of the fuse element 2 smaller than the width of the fuse element 1, the breaking threshold current of the fuse element 2 becomes lower than that of the fuse element 1. More practically, by making the width (or thickness) of at least a part of the silicide layer of the fuse element 2 smaller than the width (or thickness) of the silicide layer of the fuse element 1, the breaking threshold current of the fuse element 2 becomes lower than that of the fuse element 1. Further, it is preferable to design the fuse element 2 or to set the voltage supplied from the power source 5 so that the current passed through the series circuit of the fuse elements 1 and 2 becomes higher than the breaking threshold current of the fuse element 2. Thus, the fuse element 2 is preferentially broken in the circuit where the fuse element 1 and 2 are connected in series.

Then, as shown in FIG. 1C, the program control transistor 6 is set to be in a state of ON, and the program control transistor 7 is set to be in a state of OFF, and program voltage is applied from the power source 5 to pass a current as shown by the arrow to break the fuse element 1 (breaking 2). At this stage, substantially all the voltage supplied from the power source 5 is applied to the fuse element 1, therefore, the fuse element 1 is easily broken by passing a current which is higher than the breaking threshold current of the fuse element 1. Therefore, the fuse elements 1 and 2 can be broken while supplying a constant voltage from the power supply 5. As described above, writing is performed.

Next, the reading method of the fuse device will be described. As shown in FIG. 1D, the program control transistor 7 is set to be in a state of ON, and the program control transistor 6 is set to be in a state of OFF, and reading voltage is applied from the power source 5 to pass a current as the arrow, and thereby, data is read.

In this Example, by disposing serially the fuse elements, the number of the control transistors each having a large area is reduced, compared to a conventional device (in the conventional fuse device in which two fuse elements are used, four transistors are used), to be capable of reducing the area, and it becomes possible to ensure writing and reading by, using program voltage, performing a plurality of times of breaking of the fuse elements, and thereby enhancing shift of the resistance value of the fuse elements due to breaking.

### Example 2

First, Example 2 will be described with reference to FIG. 2.

FIGS. 2A to 2D are cross-sectional views of a fuse device for explaining an initial state of the fuse device, a writing method (breaking method) thereof, and a reading method thereof. The fuse device includes, a serially connected head fuse element 21, a fuse element 22 that is serially connected to the fuse element 21, a last-stage fuse element 23 that is serially connected to the fuse element 22, a program control transistor (MOS transistor Tr3) 26 connected to the head fuse element 21, a program control transistor (MOS transistor Tr2) 27 connected to the fuse element 22, a program control transistor (MOS transistor Tr1) 28 connected to the last-stage fuse element 23, a power source 25 connected to an end of the head fuse element 21.

A source region or a drain region of the program control transistor 26 is connected to one end of the fuse element 21, and the drain region or the source region is earthed. A source region or a drain region of the program control transistor 27 is connected to one end of the fuse element 22, and the drain region or the source region is earthed. A source region or a drain region of the program control transistor 28 is connected to one end of the fuse element 23, and the drain region or the source region is earthed. In this Example, as the fuse elements, polysilicon wires are used.

FIG. 2A shows the initial state of the fuse device.

Next, the writing method of the fuse device will be described. Writing is performed by sequentially breaking the two fuse elements. First, as shown in FIG. 2B, the program control transistor 28 is set to be in a state of ON, and the program control transistors 26, 27 are set to be in a state of OFF, and program voltage is applied from the power source 25 to pass a current as the arrow to break the fuse element 23 (breaking 1).

It is preferable that the fuse element 23 is more easily broken than the fuse elements 21 and 22. One of the methods is that the fuse element 23 is broken at a current which is lower than currents at which the fuse elements 21 and 22 are broken. For example, by making the width of the fuse element 23 smaller than the widths of the fuse elements 21 and 22, the breaking threshold current of the fuse element 23 becomes lower than those of the fuse elements 21 and 22. More practically, by making the width (or thickness) of at least a part of the silicide layer of the fuse element 23 smaller than the widths (or thicknesses) of the suicide layers of the fuse elements 21 and 22, the breaking threshold current of the fuse element 23 becomes lower than those of the fuse elements 21 and 22. Further, it is preferable to design the fuse element 23 or to set the voltage supplied from the power source 25 so that the current passed through the series circuit of the fuse elements 21, 22 and 23 becomes higher than the breaking threshold current of the fuse element 23. Thus, the fuse element 23 is preferentially broken in the circuit where the fuse elements 21, 22 and 23 are connected in series.

Then, as shown in FIG. 2C, the program control transistor 27 is set to be in a state of ON, and the program control transistors 26, 28 are set to be in a state of OFF, and a program voltage is applied from the power source 25 to pass a current as the arrow to break the fuse element 22 (breaking 2).

It is preferable that the fuse element 23 is more easily broken than the fuse element 21. As described above, one of the methods is that the fuse element 22 is broken at a current which is lower than current at which the fuse element 21 is broken. For example, by making the width of the fuse element 22 smaller than the width of the fuse element 21, the breaking threshold current of the fuse element 22 becomes lower than that of the fuse element 21. More practically, by making the width (or thickness) of the silicide layer of the fuse element 22 smaller than the width (or thickness) of at least a part of the suicide layer of the fuse element 21, the breaking threshold current of the fuse element 22 becomes lower than that of the fuse element 21. Further, it is preferable to design the fuse element 22 or to set the voltage supplied from the power source 25 so that the current passed through the series circuit of the fuse elements 21 and 22 becomes higher than the breaking threshold current of the fuse element 22. Thus, the fuse element 22 is preferentially broken in the circuit where the fuse elements 21 and 22 are connected in series.

Then, as shown in FIG. 2D, the program control transistor 26 is set to be in a state of ON, and the program control transistors 27, 28 are set to be in a state of OFF, and program voltage is applied from the power source 25 to pass a current as the arrow to break the fuse element 21 (breaking 3). At this stage, substantially all the voltage supplied from the power source 25 is applied to only the fuse element 21, therefore, the fuse element 21 is easily broken by passing a current which is higher than the breaking threshold current of the fuse element 21. Therefore, the fuse elements 21, 22 and 23 can be broken while supplying a constant voltage from the power supply 25. As described above, writing is performed.

Next, the reading method of the fuse device will be explained. As shown in FIG. 2E, the program control transistor 28 are set to be in a state of ON, and the program control transistors 26, 27 are set to be in a state of OFF, and a reading voltage is applied from the power source 25 to pass a current as the arrow, and thereby, data is read.

In this Example, by disposing serially the fuse elements, the number of the control transistors each having a large area is reduced, compared to a conventional device, to be capable of reducing the area, and it becomes possible to ensure writing and reading by, using program voltage, performing a plurality of times of breaking of the fuse elements, and thereby enhancing shift of the resistance value of the fuse elements due to breaking. Because the number of the fuse elements is larger than that of Example 1, the shift of the resistance value becomes large.

### Example 3

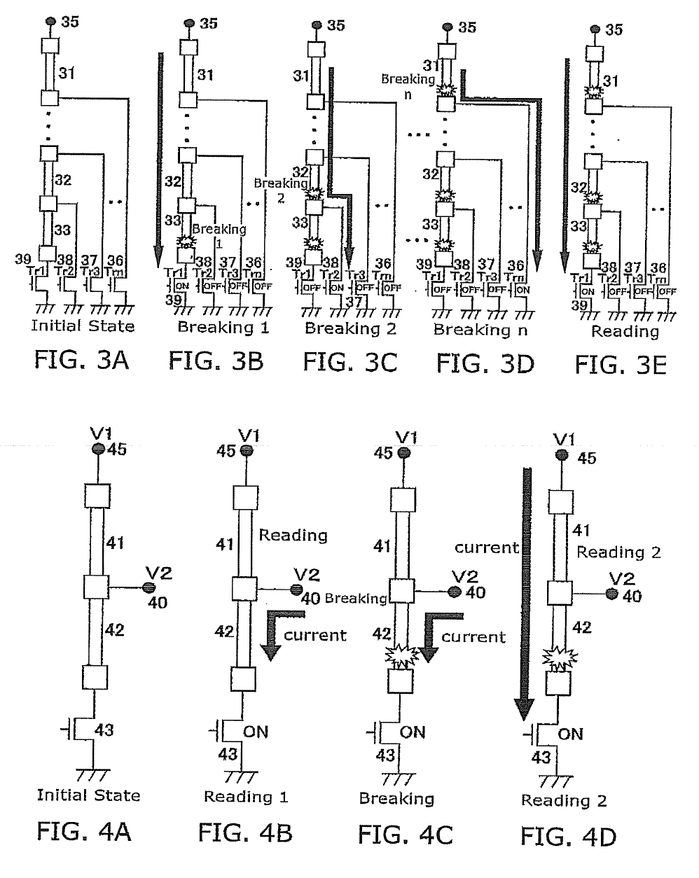

First, Example 3 will be described with reference to FIG. 3.

FIGS. 3A to 3E are cross-sectional views of a fuse device for explaining an initial state of the fuse device, a writing method (breaking method) thereof, and a reading method thereof.

The fuse device includes, a first fuse element 31 and and a (n−1)-th fuse element 32 and a n-th fuse element 33 which are serially connected and whose number is n (n is an integer of 4 or more), a program control transistor (MOS transistor Trn) 36 connected to the head first fuse element 31, a program control transistor (MOS transistor Tr3) 37 connected to the (n−2)-th fuse element, a program control transistor (MOS transistor Tr2) 38 connected to the (n−1)-th fuse element, a program control transistor (MOS transistor Tr1) 39 connected to the last-stage n-th fuse element. Furthermore, the fuse device includes a power source 35 connected to an end of the head first fuse element 31.

A source region or a drain region of each of the program control transistors are connected to one end of the fuse element, and the drain region or the source region is earthed. In this Example, as the fuse elements, polysilicon wires are used.

FIG. 3A shows the initial state of the fuse device.

Next, the writing method of the fuse device will be described. Writing is performed by sequentially breaking the respective fuse elements. First, as shown in FIG. 3B, the program control transistor 39 is set to be in a state of ON, and the other program control transistors 36, 37, 38, and so forth are set to be in a state of OFF, and program voltage is applied from the power source 35 to pass a current as the arrow to break the fuse element 33 (breaking 1).

It is also preferable that the fuse element 33 is more easily broken than the fuse elements 31, . . . , and 32. As described above, one of the methods is that the fuse element 33 is broken at a current which is lower than currents at which the fuse elements 31, and 32 are broken. For example, by making the width of the fuse element 33 smaller than the widths of the fuse elements 31, . . . and 32, the breaking threshold current of the fuse element 33 becomes lower than those of the fuse elements 31, . . . and 32. More practically, by making the width (or thickness) of at least a part of the silicide layer of the fuse element 33 smaller than the widths (or thicknesses) of the suicide layers of the fuse elements 31, . . . and 32, the breaking threshold current of the fuse element 33 becomes lower than those of the fuse elements 31, . . . and 32. Further, it is preferable to design the fuse element 33 or to set the voltage supplied from the power source 35 so that the current passed through the series circuit of the fuse elements 31, . . . and 33 becomes higher than the breaking threshold current of the fuse element 33. Thus, the fuse element 33 is preferentially broken in the circuit where the fuse elements 31, . . . and 33 are connected in series.

Then, as shown in FIG. 3C, the program control transistor 38 is set to be in a state of ON, and the program control transistors 36, 37, 39, and so forth are set to be in a state of OFF, and program voltage is applied from the power source 35 to pass a current as the arrow to break the fuse element 32 (breaking 2).

Again, it is preferable that the fuse element 32 is more easily broken than the fuse elements 31, . . . . As described above, one of the methods is that the fuse element 32 is broken at a current which is lower than currents at which the fuse elements 31, . . . are broken. For example, by making the width of the fuse element 32 smaller than the widths of the fuse elements 31, . . . , the breaking threshold current of the fuse element 32 becomes lower than those of the fuse elements 31, . . . . More practically, by making the width (or thickness) of at least a part of the silicide layer of the fuse element 32 smaller than the widths (or thicknesses) of the silicide layers of the fuse elements 31, . . . , the breaking threshold current of the fuse element 32 becomes lower than those of the fuse elements 31, . . . . Further, it is preferable to design the fuse element 32 or to set the voltage supplied from the power source 35 so that the current passed through the series circuit of the fuse elements 31, . . . and 32 becomes higher than the breaking threshold current of the fuse element 32. Thus, the fuse element 32 is preferentially broken in the circuit where the fuse elements 31, . . . and 32 are connected in series.

Then, the fuse elements are sequentially broken (breaking 1 to breaking n−1). In these steps, it is also preferable that the fuse element to be broken is more easily broken than the other unbroken fuse elements. Namely, as described above, by making the width of the fuse element to be broken smaller than the widths of the other unbroken fuse elements, the breaking threshold current of the fuse element to be broken becomes lower than those of the other unbroken fuse elements.

Then, as shown in FIG. 3D, the program control transistor 36 is set to be in a state of ON, and the program control transistors 37, 38, 39, and so forth are set to be in a state of OFF, and program voltage is applied from the power source 35 to pass a current as the arrow to break the fuse element 31 (breaking n). At this stage, substantially all the voltage supplied from the power source 35 is applied to only the fuse element 31, therefore, the fuse element 31 is easily broken by passing a current which is higher than the breaking threshold current of the fuse element 31. Therefore, the fuse elements 31, . . . , 32 and 33 can be broken while supplying a constant voltage from the power supply 35. As described above, writing is performed.

Next, the reading method of the fuse device will be described. As shown in FIG. 3E, the program control transistor 39 are set to be in a state of ON, and the program control transistors 36, 37, 38, and so forth are set to be in a state of OFF, and reading voltage is applied from the power source 35 to pass a current as the arrow, and thereby, data is read.

In this Example, by disposing serially the fuse elements, the number of the control transistors each having a large area is reduced, compared to a conventional device, to be capable of reducing the area, and it becomes possible to ensure writing and reading by, using program voltage, performing a plurality of times of breaking of the fuse elements, and thereby enhancing shift of the resistance value of the fuse elements due to breaking. Because the number of the fuse elements is larger than that of Example 2, the shift of the resistance value becomes large.

### Example 4

First, Example 4 will be described with reference to FIG. 4.

FIGS. 4A to 4D are cross-sectional views of a fuse device for explaining an initial state of the fuse device, a breaking method thereof, and a reading method thereof.

The characteristic of this Example is that the fuse device has two power sources. The fuse device includes, a head first fuse element 41 and a back-stage second fuse element 42 which are serially connected, a program control transistor (MOS transistor) 43 connected to the back-stage second fuse element 42, a first power source 45 connected to an end of the head first fuse element 41, and a second power source 40 connected to an end of the back-stage second fuse element 42. A source region or a drain region of the program control transistor 43 is connected to one end of the back-stage second fuse element 42, and the drain region or the source region is earthed.

Thus, a fuse device includes: a plurality of serially connected fuse elements whose number is n (n is an integer of two or more); a first power source being connected to one end of a first fuse element that is a top of the n serially connected fuse elements, a second power source being connected to a node between n-th fuse element at last stage of the n serially connected fuse elements and (n−1)-th fuse element at previous stage to the last stage by one stage, and a program control transistor being connected to other end of the n-th fuse element at the last stage.

In the fuse device, at least two of the fuse elements have different resistances. In the fuse device, a resistance of the first fuse elements is higher than a resistance of the n-th fuse element.

In this Example, as the fuse elements, polysilicon wires are used. The polysilicon wire is composed of a polysilicon film and a silicide layer formed on the surface of the polysilicon film. The fuse device is subjected to the writing treatment by breaking the fuse element(s). Breaking of the fuse element(s) is performed by applying program voltage to the fuse element to melt and cut the silicide layer on the polysilicon film,

FIG. 4A shows the initial state of the fuse device.

Next, the writing method of the fuse device will be described. Writing is performed by breaking the second fuse elements. First, as shown in FIG. 4C, the program control transistor 43 is set to be in a state of ON, and program voltage is applied from the second power source 40 to pass a current as the arrow to break the back-stage second fuse element 42. As described above, writing is performed.

Next, the reading method of the fuse device will be described. In this Example, the reading methods are different according to whether the fuse element is broken or not. As shown in FIG. 4B, when breaking of the fuse element is not performed (reading 1), the program control transistor 43 is set to be in a state of ON, and reading voltage is applied from the second power source (V2) 40 to pass a current as the arrow, and thereby, data is read. As shown in FIG. 4D, when breaking of the second fuse element 42 is performed (reading 2), the program control transistor 43 is set to be in a state of ON, and reading voltage is applied from the second power source (V1) 45 to pass a current as the arrow, and thereby, data is read.

In this Example, by disposing serially the fuse elements, the number of the control transistors each having a large area is reduced, compared to a conventional device, to be capable of reducing the area. Moreover, in this Example, by separating the power source for readout for the cases of breaking and not breaking, when readout is performed in the case of breaking, the resistance becomes large to be capable of certainly reading the breaking data because the extra fuse element is serially connected, compared to the case of not breaking By making the resistance of the fuse element 41 higher than the resistance of the fuse element 42, the series resistance becomes even higher, and thus, it becomes possible to read the rewritten data more certainly. In this Example, for the first power source and the second power source, one fuse element is disposed. However, instead of the one fuse element, a plurality of fuse elements may be disposed so as to be serially connected.

Thus, a method for writing data to and reading data from a fuse device having a plurality of serially connected fuse elements whose number is n (n is an integer of two or more); a first power source being connected to one end of a first fuse element that is a top of the n serially connected fuse elements, a second power source being connected to a node between n-th fuse element at last stage of the n serially connected fuse elements and (n−1)-th fuse element at previous stage to the last stage by one stage, and a program control transistor being connected to other end of the n-th fuse element at the last stage, the method includes: a data-writing of setting the program control transistor to be in a state of ON, applying a program voltage to the second power source to break the n-th fuse element, and thereby writing data; a first reading of setting the program control transistor to be in a state of ON when data writing is not performed, applying a program voltage to the second power source to break the n-th fuse element, and thereby perform readout; and a second reading of setting the program control transistor to be in a state of ON when data is written, applying a program voltage to the first power source to break the n-th fuse element, and thereby perform readout.

In the method, at least two of the fuse elements have different resistances. In the method, a resistance of the first fuse elements is higher than a resistance of the n-th fuse element

1. A fuse device comprising:
a plurality of serially connected fuse elements whose number is n (n is an integer of two or more);
a power source connected to one end of a first fuse element that is a top of the n serially connected fuse elements; and
a plurality of program control transistors, each of the program control transistors being connected to each of nodes between the fuse elements, and to an end of the n-th fuse element, respectively.

2. The fuse device according to claim 1, wherein at least two of the fuse elements have different breaking threshold currents.

3. The fuse device according to claim 1, wherein at least two of the fuse elements are different in width and/or thickness at at least a part thereof.

4. The fuse device according to claim 1, wherein breaking threshold currents of the fuse elements become higher in an order from the first fuse element to the n-th fuse element.

5. The fuse device according to claim 1, wherein the fuse elements have silicide layers.

6. A method for writing data to a fuse device having a plurality of serially connected fuse elements whose number is n (n is an integer of two or more); a power source connected to one end of a first fuse element that is a top of the n serially connected fuse elements; and a plurality of program control transistors, each of the program control transistors being connected to each of nodes between the fuse elements, and to an end of the n-th fuse element, respectively,
the method comprising:
setting the program control transistor connected to the n-th fuse element out of the n serially connected fuse elements, to be in a state of ON;
setting the program control transistor connected to each of other fuse elements, to be in a state of OFF;
applying a program voltage from the power source to break the n-th fuse element;
setting the program control transistor connected to the (n−1)-th fuse element, to be in a state of ON;
setting the program control transistor connected to each of the first through (n−2)-th fuse elements and the n-th fuse element, to be in a state of OFF;
applying a program voltage from the power source to break the (n−1)-th fuse element;
sequentially breaking the (n−2)th fuse element, . . . , second fuse element, and the first fuse element, in a same manner; and thereby
breaking all of the n fuse elements.

7. The method according to claim 6, wherein the n fuse element are broken while the program voltage is kept constant.

8. The method according to claim 6, wherein at least two of the fuse elements have different breaking threshold currents.

9. The method according to claim 6, wherein at least two of the fuse elements are different in width and/or thickness at at least a part thereof.

10. The method according to claim 6, wherein breaking threshold currents of the fuse elements become higher in an order from the first fuse element to the n-th fuse element.

11. A method for reading data from a fuse device having a plurality of serially connected fuse elements whose number is n (n is an integer of two or more); a power source connected to one end of a first fuse element that is a top of the n serially connected fuse elements; and a plurality of program control transistors, each of the program control transistors being connected to each of nodes between the fuse elements, and to an end of the n-th fuse element, respectively,
the method comprising:
setting the program control transistor connected to the n-th fuse element at a last stage of the n serially connected fuse elements, to be in a state of ON;
setting the other program control transistors to be in a state of OFF; and
applying a program voltage from the power source to perform readout.

12. The method according to claim 11, wherein at least two of the fuse elements have different breaking threshold currents.

13. The method according to claim 11, wherein at least two of the fuse elements are different in width and/or thickness at at least a part thereof.

14. The method according to claim 11, wherein breaking threshold currents of the fuse elements become higher in an order from the first fuse element to the n-th fuse element.
